(19) United States
(12) Patent Application Publication
(10) Pub. No.: US 2026/0138191 A1
(43) Pub. Date: May 21, 2026

(54) TURNING MACHINE TOOL

(71) Applicant: E.M.G. SRL, Pozzaglio ed Uniti (CR) (IT)

(72) Inventor: Giorgio GATTI, Cremona (CR) (IT)

(21) Appl. No.: 19/150,033

(22) PCT Filed: Jan. 17, 2024
(86) PCT No.: PCT/IT2024/050009

§ 371 Date: Jul. 22, 2025

(30) Foreign Application Priority Data
Jan. 24, 2023 (IT) 102023000000966

(51) Int. Cl. B23B 5/26; B23B 7/02; B23B 13/02

(52) U.S. Cl. CPC B23B 5/26; B23B 7/02; B23B 13/021

(57) ABSTRACT

The present invention is aimed at the mechanical industry sector and relates to a turning machine tool (1), suitable for machining delicate pieces of the casing type (B), which must be handled with care to avoid damage, scratches, dents, etc., comprising a substantially cylindrical body with a thin wall, a first end (B1) closed and a second end (B2) open so that said body is hollow. Said machine tool (1) comprises: —a frame structure (2) for support and resting on the ground; —feeding means of pieces to be machined and —a mandrel (4) comprising a hole (5) for housing a piece to be machined and jaws (6) for gripping and holding said piece in position; —first motor means (M1) adapted to rotate said mandrel; —a first tool (7) suitable for machining a first end of said piece, and a second tool (8) suitable for machining a second end of said piece; —means for unloading the machined pieces; —a command and control unit (100). Said machine tool (1) is characterized in that said second tool (8) is placed on the opposite side of said first tool (7) with respect to said mandrel (4), so as to allow said machine tool (1) to simultaneously machine said first and second ends of the piece held by said single mandrel (4).

### TECHNICAL FIELD OF APPLICATION

The present invention relates to the mechanical industry sector. More in detail, the invention relates to a turning machine tool, suitable to machine delicate pieces, which must be handled with care to avoid damage, scratches, dents, etc.

### BACKGROUND ART

An important component of turning machine tools is the mandrel, which allows the piece to be machined to be locked on the rotation axis with various types of tools.

As far as this is concerned, the piece to be clamped in the mandrel includes:
a hollow body, substantially cylindrical or conical in shape, with a thin wall;
a base surface placed at a first closed end of said body, while a second end of the body remains open and is defined by the edge of said thin wall.

Since it is essential to preserve the piece being machined from the risk of deformation, the choice of suitable equipment for the turning machine tool must be evaluated based on the type of surface of the piece, the machining to be carried out, the dimensional precision and the required machining tolerance.

In the following description, reference will be made to turning machine tools used in the sector of production and loading lines of cartridges for sporting, civil and military use, where said turning machine tools are suitable for machining the casings of said cartridges.

When reference is made to a piece to be machined, it will therefore mean a cartridge casing. However, the machine described below may be used indifferently, with the appropriate choice of machining tools, also for machining other objects which are always substantially cylindrical in shape and have thin walls, such as for example containment cases for cosmetic products and delicate components of the automotive market.

The casings provide that on the outer edge of their hollow body, in proximity to their first closed end, an annular groove is made, in the jargon called “grooving” or “extraction throat”, while the free edge of the thin wall in proximity to their second end is trimmed to size, and optionally flared, to facilitate the introduction of an ogive acting as a projectile.

In fact, two machining tools of the chip removal type are therefore necessary.

Traditional machine tools for turning casings include:
a frame structure for support and resting on the ground;
feeding means of casings to be machined;
a first mandrel comprising a hole for housing a casing to be machined and jaws for gripping and holding said casing in position;
a first tool suitable for machining the first end of said cartridge casing retained by said first mandrel to obtain said annular groove;
a second mandrel comprising a housing hole for said cartridge casing to be machined, already processed by said first tool, and jaws for gripping and holding said cartridge casing in position;
a second tool suitable for machining the second end of said cartridge casing retained by said second mandrel to cut to size and/or countersink the edge of its thin wall;
motor means suitable for separately rotating said first and second mandrels;
means for gripping and moving said cartridge casing from said first mandrel to said second mandrel;
means for unloading the machined casings coming out of said second mandrel;
a command and control unit adapted to supervise all the functions of the machine tool.

The traditional mandrels used in the machine tools described above are generally composed of a cylindrical body provided with radial guides along which stepped jaws slide, generally three in number, adapted to act as jaws for gripping and holding the casing in position during its rotation.

These jaws are moved along said guides, to move them further or closer from the centre of the mandrel, and therefore from the casing, by means of a special key, guaranteeing an effective grip on the piece.

In particular, the claws, or jaws, of the first mandrel grip the casing in several points corresponding to either the free edge of the second end of the casing or the inner surface of the thin wall, so that the first tool may machine the first end of the casing left free.

Otherwise, the claws, or jaws, of the second mandrel grip the case in several points corresponding to the base surface at the first end of the casing, so that the second tool may machine the second end of the casing left free.

Important drawbacks of traditional machine tools derive from the fact that the machining on the same casing takes place in succession, one after the other, in different stations of the machine.

As mentioned above, two mandrels are required, each of which is associated with a processing tool, and the machine tools must provide special means for moving the casings, from a first work station in which the first tool associated with the first mandrel is located, to a second work station where the second tool associated with the second mandrel is located.

Said systems for gripping and moving the casing from one mandrel to another to carry out the two processes separately use hydraulic or air locking systems which are slow in their operations compared to the speed with which the processes are carried out on the casing, and therefore disadvantageously cause a slowdown of the entire work cycle of the machine tool.

Furthermore, traditional mandrels exhibit some limitations and drawbacks essentially due to the punctual grip of the jaws.

The grip of the jaws in fact acts on limited portions of the casing to be machined, which as may be remembered is made up of a hollow brass body with thin walls, for example 0.2 mm, risking deforming it due to a non-uniform distribution of pressures and thrust forces.

Further drawbacks relate to the long preparation times of the machine in case of possible calibre changes of the casings in production.

In fact, the same machine may be set up to produce casings of different calibres, and it is therefore necessary, when switching from one calibre to another, to vary and manage the interactions between the various components with extreme precision (geometry of the mandrels, distance of the processing tools from the mandrels themselves, path of the means for gripping and moving the casings from one mandrel to another, etc . . . ), to allow the correct functioning of the machine and the kinematic coordination of all the moving parts.

Traditional turning machine tools are generally bulky and slow in production, with consequent economic disadvantages.

### DISCLOSURE OF THE INVENTION

The invention aims to overcome these limits, creating a turning machine tool particularly suitable for the machining of delicate thin-walled pieces, which is efficient and precise in use, which reaches high working speeds, always guaranteeing the maximum quality of the processes carried out, preserving the pieces from damage and deformations which may then compromise the efficiency thereof, and ensuring the production of pieces that are always identical to each other.

The aim of the invention is to create a turning machine tool capable of carrying out two simultaneous operations on each piece, optimizing the work of the individual components, in particular of the mandrel.

It is also the aim of the invention to create a turning machine tool that is easy and quick to set up, even in the event of a change in the type of machining or the format of the pieces.

Such objects are achieved with a turning machine tool adapted to machine delicate pieces of the casing type comprising a substantially cylindrical body with a thin wall, a first closed end and a second open end so that said body is hollow, wherein said machine tool comprises:
a frame structure for support and resting on the ground;
feeding means of pieces to be machined;
a mandrel comprising a hole for housing a piece to be machined and jaws for gripping and holding said piece in position;
first motor means adapted to rotate said mandrel;
a first tool adapted to machine a first end of said piece;
a second tool adapted to machine a second end of said piece;
means for unloading the machined pieces;
a command and control unit adapted to supervise all the functions of the machine tool,
and wherein said machine tool is characterized in that said second tool is placed on the opposite side of said first tool with respect to said mandrel, so as to allow said machine tool to simultaneously machine said first and second ends of the piece held by said single mandrel.

In a preferred variant, said machine tool comprises:
first means for translating said first tool in a direction orthogonal to an axis of the hole of said mandrel, so that said first tool works radially on said first end of said workpiece gripped in said mandrel;
second means for translating said second tool in a longitudinal direction to said axis of the hole of said mandrel, so that said second tool works axially on said second end of said workpiece gripped in said mandrel.

According to a first aspect of the invention, said mandrel comprises:
a first outer ring on which said first motor means act by means of belt transmission means;
a second inner ring, comprising said hole, slidable axially with respect to said first outer ring and comprising a first conical surface;
second motor means adapted to impart an axial movement to said second inner ring;
a plurality of jaws each provided with a first inclined plane adapted to cooperate with said first conical surface of said second inner ring,
wherein the axial displacement in one direction of said second inner ring along said first outer ring causes the sliding of said first conical surface on the inclined planes of said jaws and the consequent approach of said jaws to the workpiece housed in said hole.

Furthermore, said machine tool comprises abutment means for said jaws adapted to prevent said jaws from moving axially with respect to said first outer ring and to favour the approach of said jaws to the workpiece housed in said hole.

Preferably, said abutment means for said jaws comprise a flange, stably associated with said first outer ring, provided with a second conical surface, and said jaws each comprise a second inclined plane adapted to cooperate with said second conical surface of said flange.

In a preferred variant, said machine tool comprises a screw with a helical profile, located inside the hole of said mandrel, adapted to discharge the machining chips towards the outside of said second tool.

According to a possible embodiment variant, said machine tool comprises means for inserting a piece to be machined into said hole of said mandrel comprising:
a loading rod adapted to cooperate axially with said first end of said workpiece externally thereto;
a first translating carriage, on which said loading rod is fixed, adapted to move said loading rod and said workpiece in a longitudinal direction to the hole of said mandrel towards it.

Advantageously, at least said loading rod is associated with said first translating carriage by means of micrometric adjustment means of its length, so as to always act as a reference zero for said machine tool also when changing the size of the pieces to be machined.

Furthermore, said machine tool comprises abutment and ejection means of a machined piece from said hole of said mandrel comprising:
an abutment and discharge rod adapted to cooperate axially with said first end of said piece to be machined but passing internally therethrough through its hollow body;
a second translating carriage, on which said abutment and discharge rod is fixed, adapted to move said abutment and discharge rod and said workpiece in the longitudinal direction to the hole of said mandrel and through it.

The advantages of the invention are numerous and illustrated below.

The turning machine tool according to the invention has an important advantage: with a single mandrel it is possible to machine both ends of the piece simultaneously.

The mandrel according to the invention in fact allows the piece to be machined to be blocked along the thin wall of its hollow body, leaving both ends free for machining and accessible to tools.

Even more advantageously, the clamping obtained with the mandrel object of the invention allows the ends of the piece to be machined by acting with forces in two different directions: said first tool works radially with respect to the piece, said second tool instead works axially to the piece.

Although the piece to be worked is delicate, provided with a thin-walled hollow body, the mandrel according to the invention guarantees controlled clamping of the piece, without risk of damage.

The reciprocal sliding between the conical surface of the inner ring and the inclined planes of the jaws allows an infinitesimal movement, 0.1 mm, of the jaws themselves, acting on the piece with force control.

The transmission of the rotation motion from the first outer ring to the second inner ring, and consequently to the jaws, is due to a dragging effect by virtue of the appropriate manufacturing tolerances of the mandrel. In fact, said second inner ring rotates driven by the effect of the infinitesimal coupling tolerance with the first outer ring, and rotates with a force sufficient to absorb the effort of the tool which performs the machining radially. The mandrel is therefore not affected by excessive tangential and radial forces, further protecting the workpiece.

Advantageously, the tightening and opening of the jaws of the mandrel occurs automatically, without the need to stop the rotation of the mandrel itself, as well as the feeding and unloading of the machined pieces.

The cooperation between the loading rod and the abutment and discharge rod, placed on opposite sides of the mandrel, guarantees maximum precision when gripping the piece by the mandrel jaws; a stable and balanced grip eliminates any problem even in the case of high speeds reached by the turning machine tool.

The entire work cycle of the machine tool, from the feeding of the casing to be processed, to the closing of the mandrel, to the simultaneous machining of the two tools, to the opening of the mandrel, and to the ejection of the worked casing lasts about one second. Production times are extremely short, with consequent economic advantages.

A further advantage consists in the speed with which it is possible to prepare the machine for each calibre change of the cartridges being processed.

The micrometric adjustment of the loading rod of the means for inserting the cartridge casing into the mandrel allows any different lengths of the piece to be machined to be compensated, without actually having to modify the position of other components on the machine.

By optimizing machine setup times, which are drastically reduced, production is significantly increased with a consequent economic benefit.

### BRIEF DESCRIPTION OF THE DRAWINGS

The advantages of the invention shall appear more clearly from the following description of a preferred embodiment, made by way of an indicative and non-limiting example with reference to the figures, in which:

FIGS. 1 and 2 represent, in front and side views respectively, a turning machine tool according to the invention;

FIGS. 3, 4 and 5 represent, respectively in a plan view from above, in an axonometric view and in a side view, internal components of the machine tool in FIG. 1;

FIG. 6 represents, in section along a horizontal plane, a detail of FIG. 3;

FIG. 7 represents an even more simplified detail of FIG. 6;

FIGS. 8, 9 and 10 represent, respectively in front view, rear view and section along a horizontal plane, a mandrel belonging to the machine tool according to the invention;

FIG. 11 represents a detail of the section in FIG. 10;

FIG. 12 represents, in an axonometric view, internal components of the turning machine tool according to a possible variant of the invention;

FIG. 13 represents, in a side view, a piece machined with the turning machine tool according to the invention.

### DETAILED DESCRIPTION OF A PREFERRED EMBODIMENT OF THE INVENTION

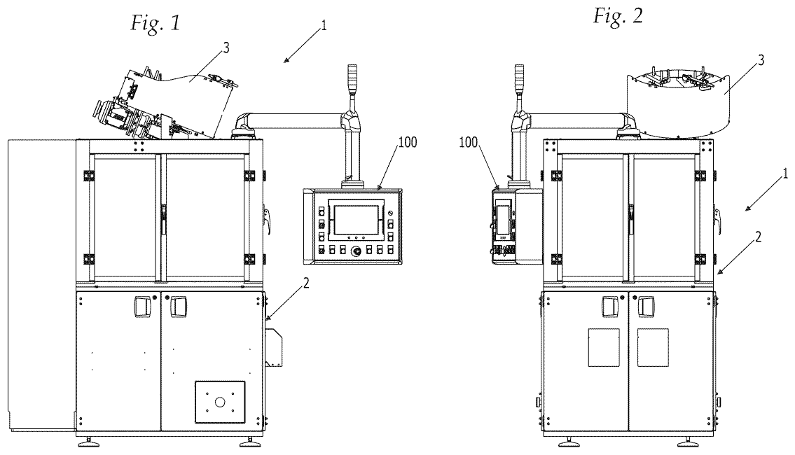

With reference to FIGS. 1-5, a turning machine tool 1 is illustrated, adapted to machine delicate pieces of the type comprising a substantially cylindrical body with a thin wall, a first closed end and a second open end so that said body is hollow or slightly conical with a section that narrows towards said second open end.

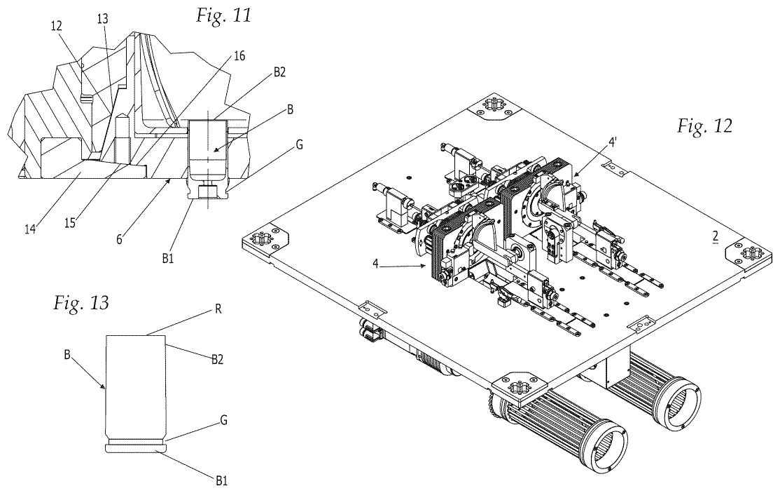

In particular, the illustrated FIGS. 1-5 refer to a machine tool 1 suitable for processing metal cartridge casings B, in order to create, by turning, both an annular groove G for extracting the cartridge casing B from the weapon after firing, made in the first end B1 of the casing, and the cut-to-size butt of the second end B2 of the casing itself, to guarantee the established length. FIG. 13 illustrates a casing B made in this way.

However, said machine tool 1 may also be advantageously used for machining not only metal casings, but also more generic pieces, always substantially cylindrical in shape and provided with thin walls and therefore sensitive to the technical drawbacks illustrated above.

In detail, said turning machine tool 1 comprises:
a frame structure for support and resting on the ground;
means for feeding casings B to be machined comprising a loading hopper 3 and a storage column according to the prior art;
a mandrel 4 comprising a hole 5, actually shaped like a tunnel, for housing a casing B to be machined and a plurality of jaws 6 for gripping and holding said casing in position;
first motor means M1, comprising a servomotor, adapted to rotate said mandrel 4, with the aid of belt transmission means 10;
a first tool 7 adapted to machine a first end B1 of said cartridge casing B to create said annular groove G;
a second tool 8 adapted to machine a second end B2 of said cartridge casing B to butt, and/or possibly countersink, the free edge R of its thin wall;
means for unloading the machined casings;
a command and control unit 100 adapted to supervise all the functions of the machine tool 1.

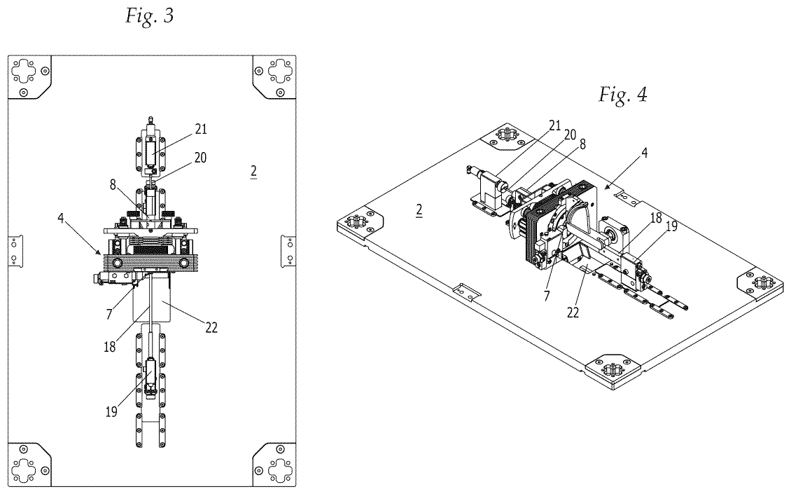

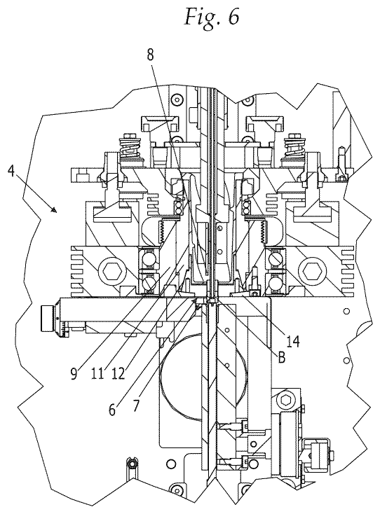

As particularly evident from FIGS. 3-5, and from the detail of FIG. 7, said second tool 8 is placed on the opposite side to said first tool 7 with respect to said mandrel 4, so as to allow said machine tool 1 to simultaneously machine said first B1 and second B2 ends of the casing B held by said mandrel 4.

The two operations are carried out simultaneously with the aid of a single mandrel 4, specially designed so that the jaws clamp only a portion of the casing B between the two ends B1 and B2, to leave both ends B1, B2 of the casing itself free and accessible.

Both machining tools 7, 8 must be able to approach the mandrel 4 when machining the casing B, and each tool 7, 8 works in a specific direction depending on the type of machining it must perform.

For this purpose, said machine tool 1 includes special translation means for each tool 7, 8.

Said machine tool 1 in fact comprises:
first translation means, of the cam oscillator type, of said first tool 7 in a direction orthogonal to an axis of the hole 5 of said mandrel 4, so that said first tool 7 works radially on said first end B1 of said cartridge casing B gripped in said mandrel 4 to create said annular groove G;
second translation means, of the cam oscillator type, of said second tool 8 in a longitudinal direction to an axis of the hole 5 of said mandrel 4, so that said second tool 8 works axially on said second end B2 of said cartridge casing B gripped in said mandrel 4 to then butt the cartridge casing itself.

Said first and second translation means of the cam oscillator type include an oil-bath cam containment box, to guarantee lifetime maintenance-free operation, transmission input and output shafts and torque limiters which prevent any overloads.

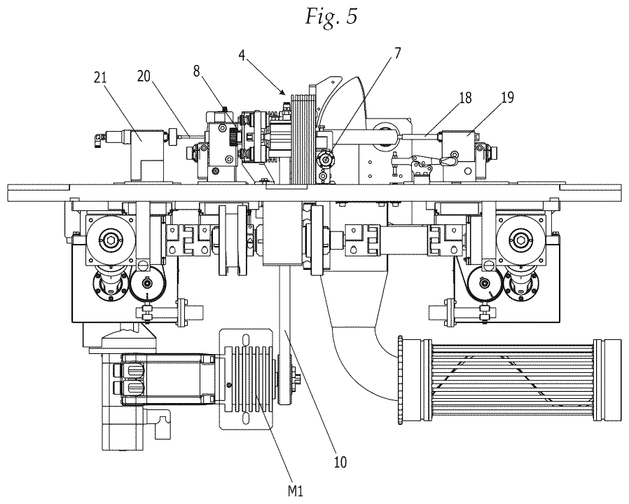

Again with reference to FIGS. 3-5 and the detail of FIG. 6, said machine tool 1 includes means for inserting the casing B to be machined, arriving from said loading hopper 3, into the hole 5 of the mandrel 4, and abutment and ejection means of the machined cartridge casing B from the hole 5 of said mandrel 4 into an opening 22 connected to a collection and discharge manifold.

Said insertion means include:
a loading rod 18 adapted to cooperate axially with said first end B1 of the casing B to be machined, externally thereto;
a first translating carriage 19, on which said loading rod 18 is fixed, adapted to move said loading rod 18 pushing said workpiece in a longitudinal direction to the hole 5 of said mandrel 4 towards it and up to the inserting the casing B into the hole 5, so that the mandrel 4 straddles the casing B.

Said loading rod 18 is associated with said first translating carriage 19 by fine adjustment means of its length, so as to be able to micrometrically vary the minimum distance between the tip of the loading rod 18 and the hole 5 of the mandrel 4 depending on the size, in particular the length, of the casing B to be machined.

This micrometric adjustment advantageously allows said loading rod 18 to always act as a reference zero for said machine tool 1, even when changing the format of the casings B to be machined.

Said abutment and ejection means comprise:
an abutment and discharge rod 20 adapted to cooperate axially with said first end B1 of said casing B to be machined but acting internally therethrough, passing through its hollow body, on the opposite side therefore with respect to said loading rod 18;
a second translating carriage 21, on which said abutment and discharge rod 20 is fixed, adapted to move said abutment and discharge rod 20 pushing said machined casing B in the longitudinal direction to the hole 5 of said mandrel 4 and letting it fall into the appropriate opening 22 below.

Said abutment and discharge rod 20 not only plays the role of ejecting the casing B machined by the mandrel 4, but during the closing step of the jaws 6 of the mandrel 4 it also acts as a fixed abutment for the loading rod 18.

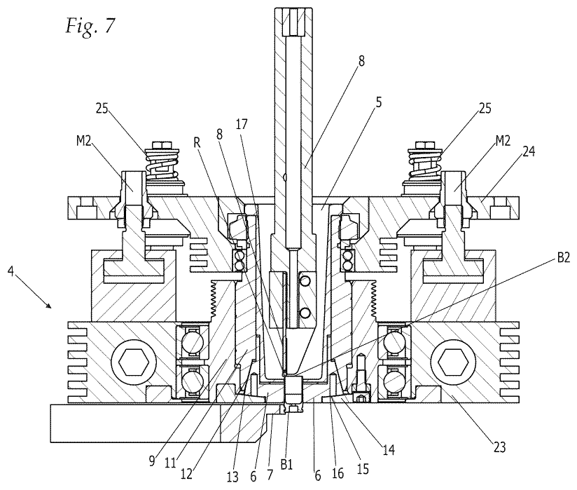

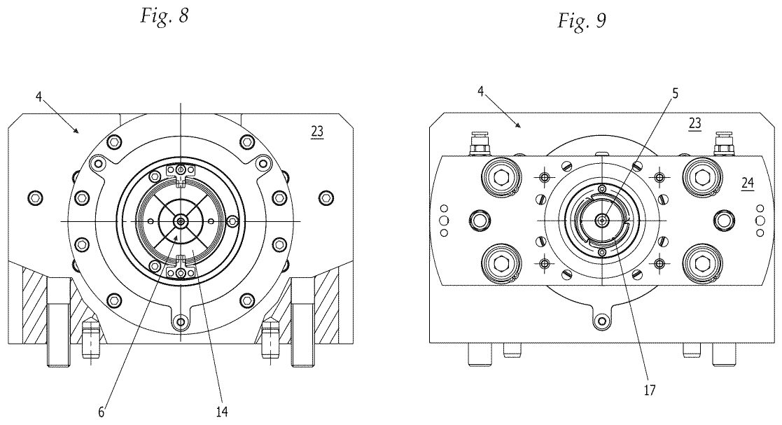

FIGS. 8-11 illustrate in detail the construction of the particular mandrel 4 present in the machine tool 1 according to the invention.

Said mandrel 4 comprises:
a fixed front plate 23;
a rear plate 24 movable with respect to said front plate 23;
a first outer ring 24, placed between said front plate 23 and said rear plate 24, on which said first motor means M1 act by means of said belt transmission means 10;
a second inner ring 11, which delimits said hole 5, also placed between said front plate 23 and said rear plate 24, slidable axially with respect to said first outer ring 9 and comprising a first conical surface 12;
second motor means M2, acting on said movable rear plate 24, adapted to impart an axial movement to said second inner ring 11;
a plurality of jaws 6, advantageously four, each provided with a first inclined plane 13 adapted to cooperate with said first conical surface 12 of said second inner ring 11.

Said second motor means M2 comprise pneumatic cylinders, adapted to push said movable rear plate 24 towards said fixed front plate 23, and consequently adapted to push said second inner ring 11.

Said second motor means M2 also include elastic return means, i.e. helical tightening springs 25, to return said rear plate 24 to the initial position, allowing said second inner ring 11 to move backwards.

In detail, the axial movement in one direction of said second inner ring 11 along said first outer ring 9 (corresponding to the approach of the movable rear plate 24 to the fixed front plate 23) causes the sliding of said first conical surface 12 on the inclined planes 13 of said jaws 6 and the consequent bringing of said jaws 6 closer to the casing B to be machined housed in said hole 5, acting like pliers in order to hold said casing B during the machining of the tools 7 and 8.

To prevent the sliding of said second inner ring 11 from causing the jaws 6 to come out axially from their seat, said machine tool 1 includes abutment means for said jaws 6.

Said abutment means are therefore suitable for preventing said jaws 6 from even moving axially with respect to said first outer ring 9.

Said abutment means for said jaws 6 comprise a flange 14, stably associated with said first outer ring 9, provided with a second conical surface 15, and said jaws 6 each comprise a second inclined plane 16 adapted to cooperate with said second conical surface 15 of said flange 14 to facilitate the approach of said jaws 6 to the casing B to be machined housed in the hole 5 of the mandrel 4.

As particularly evident from the section in FIG. 10, said machine tool 1 includes a screw 17 with a helical profile, located inside the hole 5 of said mandrel 4, adapted to discharge the machining chips of said second tool 8 towards the outside.

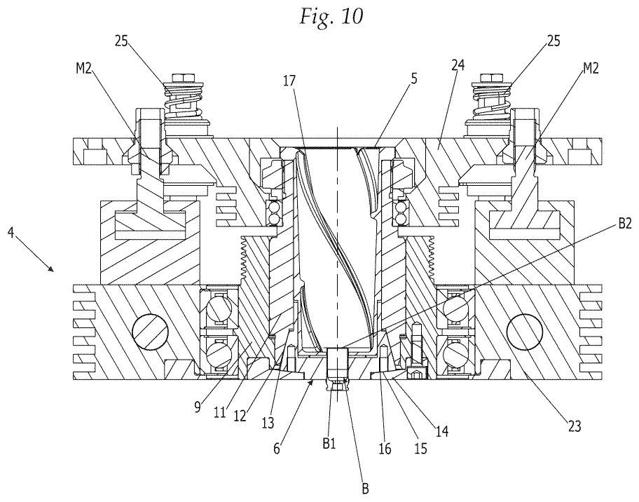

With particular reference to FIG. 12, a turning machine tool 1 is illustrated, provided with two mandrels 4, 4′ and two corresponding machining tools 7, 8 for each mandrel 4, 4′, so as to double the productivity compared to the machine tool 1 of FIG. 1. Each mandrel 4, 4′ works at a rate of 60 pieces/minute for a total production of 120 pieces/minute.

All the components of the machine tool 1 were designed and manufactured in order to obtain a machining tolerance of the final piece, casing, of ±0.05 mm.

An operating cycle of the machine tool 1 according to the invention is described below, with reference to the single machine tool of FIG. 1. However, the same operating cycle may apply to the double machine tool of FIG. 12, where the mandrels 4, 4′, the tools 7, 8 and all the related components work in synchronous and in parallel.

Before starting the work cycle, the mandrel 4 is rotated by the servomotor of the first motor means M1 connected via the belt transmission means 10. The inner ring 11 of the mandrel 4 rotates by fluidic drag by virtue of the rotation of the outer ring 9, favoured by the minimum dimensional tolerance between the two inner/outer rings.

Once the established number of revolutions has been reached, the work cycle of the machine tool 1 takes place without ever interrupting the rotation of the mandrel 4 as follows:
1) opening of the mandrel jaws: the pneumatic cylinders of the second motor means M2 act on the movable rear plate 24, returning the second inner ring 11, overcoming the force of the clamping springs 25, and therefore allowing the removal of the jaws 6 and the elastic opening of the collet of the mandrel 4.
2) ejection of the already machined casing and removal of the casing to be machined: the abutment and discharge rod 20, moved by the second translating carriage 21, ejects the casing B machined in the previous cycle, pushing it out of the hole 5 of the mandrel 4, with the aid of a blow of air. At the same time, loading means take a new casing B to be machined from the storage column and align it to the axis of the hole 5 of the mandrel 4. The movements of the loading rod 18 and of the abutment and unloading rod 20 are mechanically phased. The machined casing B falls, through the opening 22, into a collector which conveys it into a sieve in order to separate the finished casing from the machining chips.
3) loading a new casing to be machined into the mandrel: the loading rod 18 pushes the casing B inside the hole 5 of the mandrel 4. During this step, the abutment and discharge rod 20 keeps the cartridge casing pressed against the loading rod 18 under elastic spring force. Once the cartridge casing B has been positioned in the hole 5 of the mandrel 4, the loading rod 18 returns to the retracted position suitable for receiving a new cartridge casing B for the next cycle.
4) tightening of the jaws of the mandrel: pressure is removed from the two pneumatic cylinders of the second motor means M2, the helical tightening springs 25 act on the movable rear plate 24 causing the sliding of the second inner ring 11 and the sliding of said first conical surface 12 on the inclined planes 13 of said jaws 6 and the consequent approach of said jaws 6 to the cartridge casing B to be machined housed in said hole 5.
turning: translation means of the cam oscillator type move both machining tools 7, 8 to bring them closer to the cartridge casing held by the mandrel 4. Said first tool 7 works radially to make an annular groove G at the first end B1 of the cartridge casing B, while said second tool 8 works axially to butt and possibly countersink the edge R of the thin wall at the second end B2 of the cartridge casing B.

1. Turning machine tool (1) adapted to machine delicate pieces of the casing type (B) comprising a substantially cylindrical body with a thin wall, a first closed end (B1) and a second open end (B2) so that said body is hollow, wherein said machine tool (1) comprises:
a frame structure (2) for support and resting on the ground;
feeding means of pieces to be machined;
a mandrel (4) comprising a hole (5) for housing a piece to be machined and jaws (6) for gripping and holding said piece in position;
first motor means (M1) adapted to rotate said mandrel
a first tool (7) adapted to machine a first end of said piece;
a second tool (8) adapted to machine a second end of said piece;
means for unloading the machined pieces;
a command and control unit (100) adapted to supervise all the functions of the machine tool (1),
and wherein said machine tool (1) is characterized in that said second tool (8) is placed on the opposite side of said first tool (7) with respect to said mandrel (4), so as to allow said machine tool (1) to simultaneously machine said first and second ends of the piece held by said single mandrel (4).

2. Machine tool (1) according to claim 1, characterized in that it comprises first means for translating said first tool (7) in a direction orthogonal to an axis of the hole (5) of said mandrel (4), so that said first tool (7) works radially on said first end of said workpiece gripped in said mandrel (4).

3. Machine tool (1) according to claim 1, characterized in that it comprises second means for translating said second tool (8) in a longitudinal direction to said axis of the hole (5) of said mandrel so that said second tool (8) works axially on said second end of said workpiece gripped in said mandrel (4).

4. Machine tool (1) according to claim 1, characterized in that said mandrel (4) comprises:
a first outer ring (9) on which said first motor means (M1) act by means of belt transmission means (10);
a second inner ring (11), comprising said hole (5), slidable axially with respect to said first outer ring (9) and comprising a first conical surface (12);
second motor means (M2) adapted to impart an axial movement to said second inner ring (11);
a plurality of jaws (6) each provided with a first inclined plane (13) adapted to cooperate with said first conical surface (12) of said second inner ring (11),
wherein the axial displacement in one direction of said second inner ring (11) along said first outer ring (9) causes the sliding of said first conical surface (12) on the inclined planes (13) of said jaws (6) and the consequent approach of said jaws (6) to the workpiece housed in said hole (5).

5. Machine tool (1) according to claim 4, characterized in that it comprises abutment means for said jaws (6) adapted to prevent said jaws (6) from moving axially with respect to said first outer ring (9) and to favour the approach of said jaws (6) to the workpiece housed in said hole (5).

6. Machine tool (1) according to claim 5, characterized in that said abutment means for said jaws (6) comprise a flange (14), stably associated with said first outer ring (9), provided with a second conical surface (15), and said jaws (6) each comprise a second inclined plane (16) adapted to cooperate with said second conical surface (15) of said flange (14).

7. Machine tool (1) according to claim 1, characterized in that it comprises a screw (17) with a helical profile, located inside the hole (5) of said mandrel adapted to discharge the machining chips towards the outside of said second tool (8).

8. Machine tool (1) according to claim 1, characterized in that it comprises means of insertion of a workpiece in said hole (5) of said mandrel (4) comprising:
a loading rod (18) adapted to cooperate axially with said first end of said workpiece externally thereto;
a first translating carriage (19), on which said loading rod (18) is fixed, adapted to move said loading rod (18) and said workpiece in a longitudinal direction to the hole (5) of said mandrel (4) towards it.

9. Machine tool (1) according to claim 8, characterized in that at least said loading rod (18) is associated with said first translating carriage (19) by means of micrometric adjustment means of its length, so as to always act as a reference zero for said machine tool (1) also when changing the size of the pieces to be machined.

10. Machine tool (1) according to claim 1, characterized in that it comprises abutment and ejection means of a workpiece from said hole (5) of said mandrel (4) comprising:
an abutment and discharge rod (20) adapted to cooperate axially with said first end of said piece to be machined but passing internally therethrough through its hollow body;
a second translating carriage (21), on which said abutment and discharge rod (20) is fixed, adapted to move said abutment and discharge rod (20) and said workpiece in the longitudinal direction to the hole (5) of said mandrel (4) and through it.

11. (canceled)
